(19) United States
(12) Patent Application Publication
(10) Pub. No.: US 2007/0180074 A1
(43) Pub. Date: Aug. 2, 2007

(54) Logic in a system that enables and disables support for a remote control based on whether an external device is coupled to the system

(76) Inventors: Frederick L. Lathrop, Houston, TX (US); Nazih H. Hage, Houston, TX (US); Christopher W. Larsen, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/343,794

(22) Filed: Jan. 31, 2006

(51) Int. Cl. G06F 15/177

(52) U.S. Cl. 709/222

(57) ABSTRACT

A system comprises a transceiver adapted to receive signals from any of a plurality of remote controls and logic that operatively couples to the transceiver. The logic enables and disables support for at least one of the remote controls based on whether an external device, which supports the remote control, is coupled to the system.

### BACKGROUND

Some systems include wireless remote control capability. For example, some computers comprise a wireless transceiver that receives signals from a remote control to control one or more system functions such as navigating a cursor on a display. In some cases, another device can be coupled to the computer and such other device may also include a wireless transceiver with its own remote control. For such a combined system, a user can use either remote control. In that two wireless transceivers are present and adapted to receive signals from a common remote control, the unfortunate possibility exists that both transceivers will receive and cause multiple responses for a single user action with a single remote control. For example, a user may press an “up arrow” key on one remote control to move the cursor in an upward direction on a display. Both transceivers will receive the wireless signal and both transceivers will interact with other logic to attempt to cause the cursor to move in the desired direction. A remote control operational conflict occurs in a situation in which two or more transceivers are present which can each react to a signal from a common remote control.

### BRIEF DESCRIPTION OF THE DRAWINGS

For a detailed description of exemplary embodiments of the invention, reference will now be made to the accompanying drawings in which:

FIG. 1 shows a system in accordance with various embodiments of the invention;

FIG. 2 shows an embodiment of the invention in which an external device is not coupled to a computer;

FIG. 3 shows a method in accordance with embodiments of the invention; and

FIG. 4 shows a schematic diagram of logic in accordance with embodiments of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

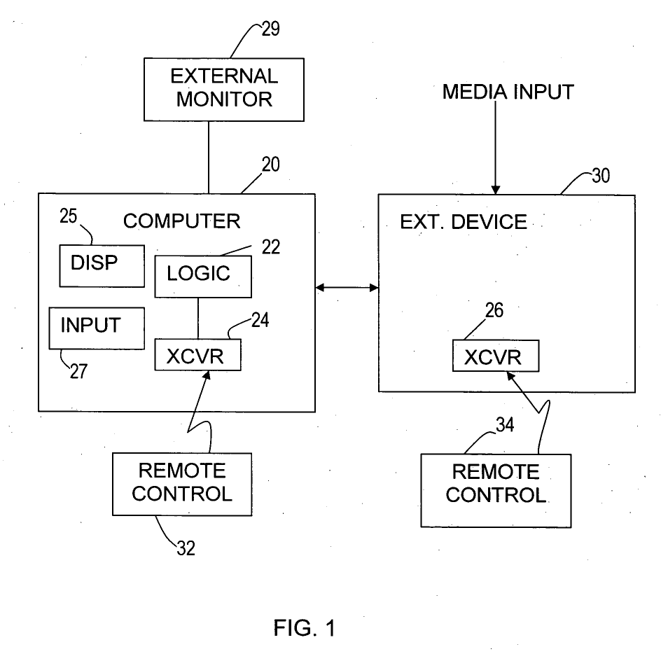

FIG. 1 shows a system comprising a computer 20 and an external device 30 coupled to the computer 20. In some embodiments, the computer 20 comprises a portable computer (e.g., a notebook computer), but in other embodiments computer 20 need not be portable. The computer 20 comprises logic 22 that operatively couples to a first wireless transceiver 24. Wireless transceiver 24 is adapted to receive wireless signals from any one or more of a plurality of remote controls such as a first remote control 32 and a second remote control 34. Any one or more of a variety of functions can be performed via a human using a remote control 32, 34, such as moving a cursor on a display 25 of the computer 20. Icons associated with applications can be selected for execution by a remote control as well. The computer 20 also comprises an input device 27, such as a keyboard, mouse, etc., that enables a user to interact with the computer. An external monitor 29 can be coupled to the computer 20 as desired.

The external device 30 comprises at least a second transceiver 26 and may comprise other components as well. In some embodiments, the external device 30 comprises a media center and, as such, is adapted, for example, to receive and decode (e.g., tune) a media input signal. In some embodiments, the media input signal comprises a television broadcast (e.g., cable television, media streaming over the Internet, etc.). Via the display 25, included as part of the computer 20, or the external monitor 29, if present, the external device 30 (media center) plays the broadcast included within the media input signal. The external device can be operated by way of remote control 34.

In at least some embodiments, the external device 30 comprises a universal serial bus (USB)-based device that couples to the computer 20 via a USB port on the computer. Further, the computer 20 is capable of plug-n-play detection which means that the computer 20 can detect the external device being added to (connected) or removed from (disconnected) from the system.

The remote controls 32 and 34 may be infrared (IR)-based or radio frequency (RF)-based and the transceivers 24 and 26 have reception and transmission capabilities (IR or RF) corresponding to the remote controls. In some embodiments, the transceivers 24, 26 can transmit signals to the remote controls, in addition to receiving signals, but in other embodiments, the transceivers only receive and do not transmit. The term “transceiver” includes receive-only devices as well as receive/transmit devices.

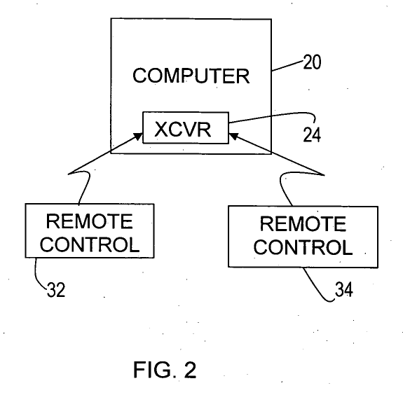

The computer 20 depicted in FIG. 1 can be used with or without the external device 30. FIG. 2 illustrates an embodiment in which the external device 30 is not coupled to the computer 20. In the embodiment of FIG. 2, the computer's transceiver 24 receives wireless signals from either remote control 32 or 34, and logic 22 processes the received signals. Because the computer can receive and process signals from both remotes, either remote control can be used, and thus both remote controls need not be carried around by the user for controlling the computer 20.

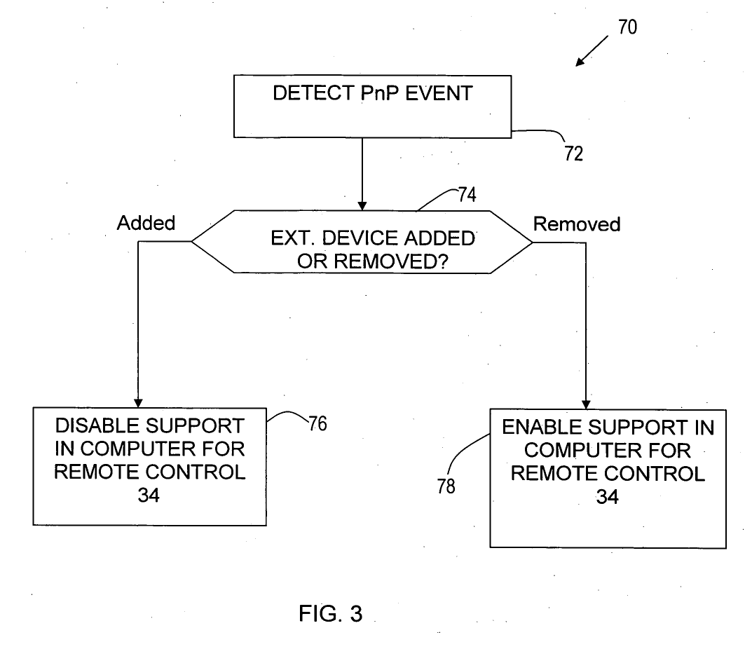

Referring again to FIG. 1, the external device 30 is coupled to the computer 20 and thus both transceivers 24 and 26 are present and operational. Embodiments of the invention ensure that each transceiver receives and processes signals from only one remote, thereby preventing remote control operational conflict in which each of two transceivers receives and processes a signal from a common remote control. In the embodiment of FIG. 3, the computer 20 is configured to process wireless signals from remote control 32 and not remote control 34. External device 30 receives and processes signals from remote control 34, not remote control 32. In some embodiments, the computer 20 is configured to selectively receive and process signals from any of a plurality of remote controls. The external device's transceiver 26, however, receives and responds to signals from only remote control 34. In such embodiments, the possibility of remote control operational conflict only exists with respect to the computer 20. The computer 20 disables support for remote control 34 if the external device 30 is coupled to the computer and enables support otherwise. By enabling and disabling support in the computer 20 for remote control 34 based on whether the external device 30 is coupled to the computer 20, the potential for remote operational conflict is ameliorated or eliminated.

FIG. 3 illustrates a method 70 comprising actions 72-78 that are performed by logic 22 (FIG. 1). At 72, the computer 20 detects an occurrence of a plug-n-play event associated with the addition or removal of the external device 30. If, as determined at 74, the external device has been added, then action 76 is performed. Otherwise, if the external device 30 has been removed, action 78 is performed. Action 76 comprises disabling support in the computer for remote control 34. Action 78 comprises enabling support in the computer for remote control 34.

In addition to being performed upon detection of a plug-n-play event, the decision as to whether to enable or disable support for remote control 34 is also performed during system initialization and/or during a resume from a low power state (e.g., sleep) in which plug-n-play events would not occur because the system would not be able to respond to hot device connections. During initialization, the computer 20 (e.g., logic 22) determines whether the external device 30 is coupled to the computer and performs action 76 or 78 accordingly.

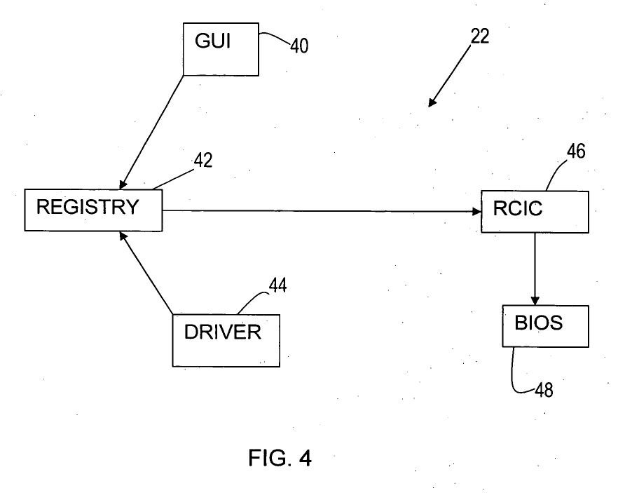

The logic 22 determines whether or not the external device 30 is coupled to the computer 20 and, accordingly, enables and disables support for remote control 34. The logic 22 may comprise hardware (e.g., a processor or other logic circuits), software, or a combination thereof. FIG. 4 illustrates an embodiment of logic 22 as comprising a graphical user interface (GUI) 40, a registry 42, a device driver 44, a remote control input coordinator (RCIC) 46, and a basic input/output system (BIOS) 48.

The GUI 40 enables a user, via display 25 and input device 27, to configure the remote control features of the system as desired. For example, via the GUI 40, a user can enable and/or disable universal remote control support and set up addressable remote control support. In the latter example, the system is configured to respond to input from only those remote controls that correspond to a selected address(es).

The information configured via GUI 40 is stored in registry 42. The registry 42 is accessed during a plug-n-play event and during system initialization for the computer to determine its configuration as described above. The driver 44 processes input from input devices including, for example, remote controls 32 and 34.

The RCIC 46 accesses the registry 42 during an external device plug-n-play event and during system initialization. Based on the information stored in the registry regarding the desired remote control operation, the RCIC 46 causes the BIOS 48 to enable or disable support for the remote control 34.

In at least some embodiments, the remote controls 32, 34 and transceivers 24, 26 comply with a suitable remote control protocol such as the RC-6 protocol. In the RC-6 protocol, and others, the activation of the remote control (e.g., pressing a button on the remote control) causes the remote control to wirelessly transmit a packet comprising a header and a data payload. One or more bits in the header and/or data payload indicate the “class” (or unique identifier) of the associated remote control. Each remote control belongs to one of a plurality of classes. For example, remote control 32 belongs to one class, while remote control 34 belongs to another class. The transmitted packets from the remote controls includes an indication of the class of that remote control and thus the computer (e.g., the logic 22) can determine which remote control transmitted a given packet.

To disable support for the remote control 34, the BIOS 48 writes the class (or unique identifier) of remote control 34 to storage (memory, register, etc.) to indicate that that remote control has been disabled. Accordingly, any packets received from remote control 34, when support for that remote has been disabled, may be received by the computer's transceiver 24 and passed on to the logic 22, but, upon receipt are subsequently, ignored by the logic 22. In some embodiments, the transceiver 24 itself is programmed to ignore packets from non-supported remote controls. To enable support for the remote control 34, its class (or unique identifier) is erased from storage.

In other embodiments, the reverse process is provided to enable and disable remote control support. That is, the class (or unique identifier) is erased from storage to enable remote control support and written to storage to disable support.

The above discussion is meant to be illustrative of the principles and various embodiments of the present invention. Numerous variations and modifications will become apparent to those skilled in the art once the above disclosure is fully appreciated. For example, rather than disabling support for the remote control 34 in the computer 20, the computer's transceiver 24 could be turned off thereby precluding the computer from receiving and responding to signals from remote control 34, or any other remote control. It is intended that the following claims be interpreted to embrace all such variations and modifications.

What is claimed is:

1. A system, comprising:
a transceiver adapted to receive signals from any of a plurality of remote controls; and
logic that operatively couples to said transceiver and that enables and disables support for at least one remote control based on whether an external device, which supports said at least one remote control, is coupled to said system.

2. The system of claim 1 wherein said logic comprises a basic input/output system (BIOS).

3. The system of claim 1 wherein said logic enables support for said at least one remote control if said external device is not coupled to said system.

4. The system of claim 1 wherein said logic disables support for said at least one remote control if said external device is coupled to said system.

5. The system of claim 1 wherein said system comprises a computer, said external device comprises a media center, and said at least one remote control is used to control operation of said media center.

6. The system of claim 1 wherein said logic determines whether said external device is coupled to said system by detecting a plug-n-play event associated with said external device.

7. The system of claim 1 wherein the logic disables support for at least one of said remote controls by turning off said transceiver.

8. A system, comprising:
a computer comprising a first transceiver adapted to support at least a first remote and a second remote control;
a device adapted to be coupled to said computer and comprising a second transceiver that receives signals from said second remote control;
wherein said computer comprises logic determines whether said device is coupled to said computer and selectively disables support for said second remote control if said device is coupled to said computer.

9. The system of claim 8 wherein said logic enables support for said second remote control if said device is not coupled to said computer.

10. The system of claim 9 wherein said logic disables support by disabling power to said first transceiver.

11. The system of claim 8 wherein said logic determines whether said device is coupled to said computer by detecting a plug-n-play event associated with said device.

12. The system of claim 8 wherein said logic comprises a basic input/output system (BIOS).

13. A method, comprising:
determining whether a device external to a computer is coupled to said computer, said computer comprises a first wireless receiver that is adapted to receive wireless signals from a plurality of remote controls comprising at least first and second remote controls, and said external device comprises a second wireless receiver that is adapted to receive wireless signals from said second remote control;
if said external device is not coupled to said computer, enabling support in the computer for at least two remote controls including said second remote control; and
if said external device is coupled to said computer, disabling support in the computer for the second remote control.

14. The method of claim 13 wherein enabling support in the computer for said at least two remote controls includes enabling support for said first and second remote controls.

15. The method of claim 13 wherein enabling and disabling support in the computer for said at least two remote controls comprises turning power on and off, respectively, to the first wireless transceiver.
